(19) United States
(12) Patent Application Publication
(10) Pub. No.: US 2023/0041601 A1
(43) Pub. Date: Feb. 9, 2023

(54) Conditional Handovers for Non-Terrestrial Networks

(71) Applicant: APPLE INC., Cupertino, CA (US)

(72) Inventors: Sarma V. Vangala, Campbell, CA (US); Alexander Sirotkin, Herzliya (IL); Fangli XU, Beijing (CN); Haijing Hu, Beijing (CN); Naveen Kumar R. Palle Venkata, San Diego, CA (US); Pavan Nuggehalli, San Carlos, CA (US); Yuqin Chen, Shenzhen (CN); Zhibin Wu, Los Altos, CA (US); Sethuraman Gurumoorthy, San Jose, CA (US); Ralf Rossbach, Munich (DE)

(21) Appl. No.: 17/439,325

(22) PCT Filed: Aug. 4, 2021
(86) PCT No.: PCT/CN2021/110457

§ 371 Date: Sep. 14, 2021

(51) Int. Cl. H04W 36/00; H04W 36/32; H04W 36/30

(52) U.S. Cl. CPC H04W 36/00837; H04W 36/0058; H04W 36/32; H04W 36/30; H04W 84/06

(57) ABSTRACT

A UE may perform a location-based conditional handover (CHO) based on a region information and size parameter associated with a serving cell of a non-terrestrial network (NTN). In time-based CHO, the UE may perform CHO in response to expiration of a network-configured wait time. Alternatively, the UE may perform CHO by randomly selecting a wait time from a network configured time range. The selection may be randomized using a network provided seed or using a cell Radio Network Temporary Identifier (RNTI) value. In elevation-based CHO, the UE may perform CHO in response to the elevation angle of a satellite being less than a network configured threshold. When the UE is configured with multiple cells of the NTN, and the CHO criteria for two or more of the cells are satisfied, the UE may select a target cell for CHO based on network indicated prioritization of the cells.

### FIELD

The present disclosure relates to the field of wireless communication, and more particularly, to mechanisms for performing conditional handover in a non-terrestrial network.

### DESCRIPTION OF THE RELATED ART

In a non-terrestrial network (NTN), a user equipment (UE) may communicate with a base station via a non-terrestrial platform (NTP) such as a satellite, a high altitude platform (HAP), an unmanned aerial vehicle (UAV), or an aircraft. The coverage areas of the cells of the NTN may move on the surface of the earth in response to the motion (e.g., orbital motion) of the corresponding NTPs. The UE may need to execute a handover from a current serving cell to a new cell, e.g., when the UE is about to exit the coverage area of the current serving cell due to the mobility of the satellites. Thus, there exists a need for a mechanism to enable handovers of UEs between NTN cells.

### SUMMARY

In some embodiments, a user equipment (UE) may be configured to receive region information and a size parameter from a non-terrestrial network (NTN). The region information may indicate a region for a serving cell associated with a non-terrestrial platform (NTP) of the NTN. The size parameter may indicate a size of a neighborhood of a boundary of the region. In response to determining that a current location of the UE is within the neighborhood, the UE may execute a conditional handover (CHO) from the serving cell to a target cell of the NTN.

In some embodiments, a user equipment (UE) may be configured to receive time information from a non-terrestrial network (NTN). The time information may be associated with a serving cell of the NTN. In response to receiving the time information, the UE may initiate a timer with a time value that is determined using the timer information. In response to expiration of the timer, the UE may execute a conditional handover (CHO) from the serving cell to a target cell of the NTN.

In some embodiments, the time information may include an indication of the time value. Alternatively, the time information may include a random seed and an indication of a time range, where the time value is randomly selected from the timer range based on the random seed. As yet another alternative, the time information may include: a UE-specific random value; and an indication of a time range, wherein the time value is selected from the time range based on the UE specific random value.

In some embodiments, a user equipment (UE) may be configured to receive information indicating an elevation angle threshold for a non-terrestrial platform (NTP) associated with a current serving cell of a non-terrestrial network (NTN). The UE may then determine an elevation angle of the NTP. In response to determining that the elevation angle is less than the elevation angle threshold, the UE may execute a conditional handover to a target cell of the NTN.

In some embodiments, the action of determining the elevation angle of the NTP may include: determining a position of the NTP based on ephemeris data of the NTP; and determining the elevation angle of the NTP based the NTP position and a current location of the UE.

In some embodiments, a user equipment (UE) may be configured to receive configuration information, wherein, for each of a plurality of potential target cells in a non-terrestrial network (NTN), the configuration information indicates (a) a corresponding priority level and (b) corresponding indication information defining a corresponding conditional handover (CHO) criterion. In response to determining the CHO criteria for two or more of the potential target cell are satisfied, the UE may selecting the cell, among the two or more potential target cells, that has the highest priority level. The UE may then execute a conditional handover to the selected cell.

In some embodiments, a non-transitory memory medium may store program instructions. The program instructions, when executed by processing circuitry, may cause the processing circuitry to perform any of the method embodiments described above.

In some embodiments, a user equipment (UE) device may include a radio subsystem; processing circuitry coupled to the radio subsystem; and memory storing program instructions. The program instructions, when executed by the processing circuitry, may cause the UE device to perform any of the method embodiments described above.

In some embodiments, a non-transitory memory medium may store program instructions. The program instructions, when executed by processing circuitry, may cause the processing circuitry to perform any of the method embodiments described above.

In some embodiments, a base station may include a radio subsystem; processing circuitry coupled to the radio subsystem; and memory storing program instructions. The program instructions, when executed by the processing circuitry, may cause the base station to perform any of the method embodiments described above.

### BRIEF DESCRIPTION OF THE DRAWINGS

A better understanding of the present subject matter can be obtained when the following detailed description of the preferred embodiment is considered in conjunction with the following drawings.

FIGS. 1-2 illustrate examples of wireless communication systems, according to some embodiments.

FIG. 3 illustrates an example of a base station in communication with a user equipment device, according to some embodiments.

FIG. 4 illustrates an example of a block diagram of a user equipment (UE) device, according to some embodiments.

FIG. 5 illustrates an example of a block diagram of a base station, according to some embodiments.

FIG. 6 illustrates an example of a user equipment 600, according to some embodiments.

FIG. 7 illustrates an example of a base station 700, according to some embodiments. The base station 700 may be used to communicate with user equipment 600 of FIG. 6.

FIG. 8 illustrates an example of a method for performing conditional handover, according to some embodiments.

FIG. 9A illustrates an example of a square region associated with conditional handover from a serving cell of a non-terrestrial network (NTN), according to some embodiments.

FIG. 9B illustrates an example of a neighborhood (crosshatched) of the boundary of the square region of FIG. 9A, according to some embodiments.

FIG. 10A illustrates an example of hexagonal region associated with conditional handover from a serving cell of an NTN, according to some embodiments.

FIG. 10B illustrates an example of a neighborhood (crosshatched) of the boundary of the hexagonal region of FIG. 10A, according to some embodiments.

FIG. 11 illustrates an example of a method for performing location-based conditional handover of a user equipment that communicates with a non-terrestrial network, according to some embodiments.

FIG. 12 illustrates an example of a method for performing timer-based conditional handover of a user equipment between cells of a non-terrestrial network, according to some embodiments.

FIG. 13A illustrates an example of a method for performing elevation-based conditional handover of a user equipment between cells of a non-terrestrial network, according to some embodiments.

FIG. 13B illustrates an example of an elevation angle of a non-terrestrial platform (such as a satellite), according to some embodiments.

FIG. 14A illustrates an example of a method for operating a user equipment (UE), to facilitate a conditional handover (CHO) in a non-terrestrial network, based on one or more CHO criteria other than signal quality, according to some embodiments.

FIG. 14B illustrates an example of a method for operating a base station (BS), to facilitate a conditional handover (CHO) of a user equipment, based on one or more CHO criteria other than signal quality, according to some embodiments.

FIG. 15 illustrates an example of a scenario where a plurality of satellites are configured for a user equipment, according to some embodiments.

FIG. 16 illustrates an example of a method for enforcing a scheme of prioritization for conditional handover among a plurality of potential target cells in a non-terrestrial network, according to some embodiments.

While the features described herein are susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE EMBODIMENTS

### Acronyms

The following acronyms are used in this disclosure.

3GPP: Third Generation Partnership Project

3GPP2: Third Generation Partnership Project 2

5G NR: 5^{th} Generation New Radio

BW: Bandwidth

BWP: Bandwidth Part

CA: Carrier Aggregation

CC: Component Carrier

CHO: Conditional Handover

CSI: Channel State Information

CSI-RS: CSI Reference Signal

DCI: Downlink Control Information

DL: Downlink

DRB: Data Radio Bearer

eNB (or eNodeB): Evolved Node B, i.e., the base station of 3GPP LTE

EN-DC: E-UTRA—NR Dual Connectivity

E-UTRA: Evolved Universal Terrestrial Radio Access

FR n: Frequency Range n

gNB (or gNodeB): next Generation NodeB, i.e., the base station of 5G NR

HARQ: Hybrid Automatic Repeat Request

LTE: Long Term Evolution

LTE-A: LTE-Advanced

MAC: Medium Access Control

MAC-CE: MAC Control Element

MIMO: Multiple-Input Multiple-Output

NR: New Radio

NR-DC: NR Dual Connectivity

NSA: Non-Standalone

NW: Network

PBCH: Physical Broadcast Channel

PDCCH: Physical Downlink Control Channel

PDCP: Packet Data Convergence Protocol

PDU: Protocol Data Unit

PDSCH: Physical Downlink Shared Channel

PRB: Physical Resource Block

QAM: Quadrature Amplitude Modulation

RAN: Radio Access Network

RAT: Radio Access Technology

RLC: Radio Link Control

RLM: Radio Link Monitoring

RNTI: Radio Network Temporary Identifier

RRC: Radio Resource Control

RRM: Radio Resource Management

RS: Reference Signal

RTT: Round Trip Time

SCI: Sidelink Control Information

SN: Sequence Number

SR: Scheduling Request

SSB: Synchronization Signal/PBCH Block

TB: Transport Block

UE: User Equipment

UL: Uplink

UMTS: Universal Mobile Telecommunications System

### Terms

The following is a glossary of terms used in this disclosure:

Memory Medium—Any of various types of memory devices or storage devices. The term “memory medium” is intended to include an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may include other types of memory as well or combinations thereof. In addition, the memory medium may be located in a first computer system in which the programs are executed, or may be located in a second different computer system which connects to the first computer system over a network, such as the Internet. In the latter instance, the second computer system may provide program instructions to the first computer for execution. The term “memory medium” may include two or more memory mediums which may reside in different locations, e.g., in different computer systems that are connected over a network. The memory medium may store program instructions (e.g., embodied as computer programs) that may be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks may range from fine grained (combinatorial logic or look up tables) to coarse grained (arithmetic logic units or processor cores). A programmable hardware element may also be referred to as “reconfigurable logic”.

Computer System—any of various types of computing or processing systems, including a personal computer system (PC), mainframe computer system, workstation, network appliance, Internet appliance, personal digital assistant (PDA), personal communication device, smart phone, television system, grid computing system, or other device or combinations of devices. In general, the term “computer system” can be broadly defined to encompass any device (or combination of devices) having at least one processor that executes instructions from a memory medium.

User Equipment (UE) (or “UE Device”)—any of various types of computer systems devices which are mobile or portable and which performs wireless communications. Examples of UE devices include mobile telephones or smart phones (e.g., iPhone™, Android™-based phones) or satellite phones, portable gaming devices (e.g., Nintendo DS™, PlayStation Portable™, Gameboy Advance™, iPhone™), wearable devices (e.g., smart watch, smart glasses), laptops, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

Base Station—The term “Base Station” has the full breadth of its ordinary meaning, and at least includes a wireless communication station configured to wirelessly communicate with user equipment (UE) devices and to provide access to a communication network for the UE devices.

Processing Element—refers to any of various elements or combinations of elements. Processing elements include, for example, circuits such as an ASIC (Application Specific Integrated Circuit), portions or circuits of individual processor cores, entire processor cores, individual processors, programmable hardware devices such as a field programmable gate array (FPGA), and/or larger portions of systems that include multiple processors.

Automatically—refers to an action or operation performed by a computer system (e.g., software executed by the computer system) or device (e.g., circuitry, programmable hardware elements, ASICs, etc.), without user input directly specifying or performing the action or operation. Thus the term “automatically” is in contrast to an operation being manually performed or specified by the user, where the user provides input to directly perform the operation. An automatic procedure may be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form may be automatically filled out by the computer system where the computer system (e.g., software executing on the computer system) analyzes the fields of the form and fills in the form without any user input specifying the answers to the fields. As indicated above, the user may invoke the automatic filling of the form, but is not involved in the actual filling of the form (e.g., the user is not manually specifying answers to fields but rather they are being automatically completed). The present specification provides various examples of operations being automatically performed in response to actions the user has taken.

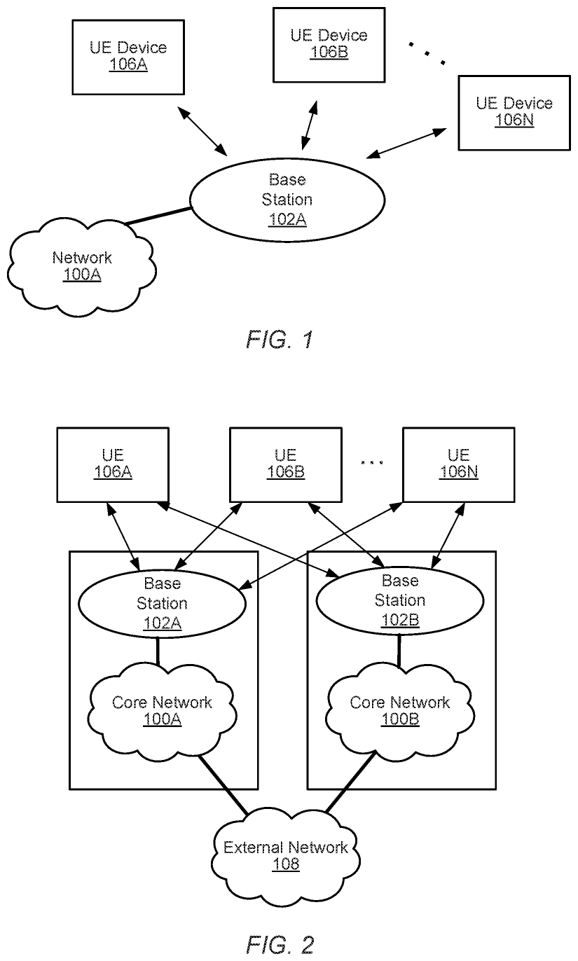

### FIGS. 1-3: Communication System

FIGS. 1 and 2 illustrate exemplary (and simplified) wireless communication systems. It is noted that the systems of FIGS. 1 and 2 are merely examples of certain possible systems, and various embodiments may be implemented in any of various ways, as desired.

The wireless communication system of FIG. 1 includes a base station 102A which communicates over a transmission medium with one or more user equipment (UE) devices 106A, 106B, etc., through 106N. Each of the user equipment devices may be referred to herein as “user equipment” (UE). In the wireless communication system of FIG. 2, in addition to the base station 102A, base station 102B also communicates (e.g., simultaneously, or concurrently) over a transmission medium with the UE devices 106A, 106B, etc., through 106N.

The base stations 102A and 102B may be base transceiver stations (BTSs) or cell sites, and may include hardware that enables wireless communication with the user devices 106A through 106N. Each base station 102 may also be equipped to communicate with a core network 100 (e.g., base station 102A may be coupled to core network 100A, while base station 102B may be coupled to core network 100B), which may be a core network of a cellular service provider. Each core network 100 may be coupled to one or more external networks (such as external network 108), which may include the Internet, a Public Switched Telephone Network (PSTN), or any other network. Thus, the base station 102A may facilitate communication between the user devices and/or between the user devices and the network 100A; in the system of FIG. 2, the base station 102B may facilitate communication between the user devices and/or between the user devices and the network 100B.

The base stations 102A and 102B and the user devices may be configured to communicate over the transmission medium using any of various radio access technologies (RATs), also referred to as wireless communication technologies, or telecommunication standards, such as GSM, UMTS (WCDMA), LTE, LTE-Advanced (LTE-A), 5G New Radio (NR), 3GPP2 CDMA2000 (e.g., 1xRTT, 1xEV-DO, HRPD, eHRPD), Wi-Fi, WiMAX etc.

For example, base station 102A and core network 100A may operate according to a first cellular communication standard (e.g., 5G NR) while base station 102B and core network 100B operate according to a second cellular communication standard. The second cellular communication standard (e.g., LTE, GSM, UMTS, and/or one or more CDMA2000 cellular communication standards) may be different from the first cellular communication standard or the same. The two networks may be controlled by the same network operator (e.g., cellular service provider or “carrier”), or by different network operators. In addition, the two networks may be operated independently of one another (e.g., if they operate according to different cellular communication standards), or may be operated in a somewhat coupled or tightly coupled manner.

Note also that while two different networks may be used to support two different cellular communication technologies, such as illustrated in the network configuration shown in FIG. 2, other network configurations implementing multiple cellular communication technologies are also possible. As one example, base stations 102A and 102B might operate according to different cellular communication standards but couple to the same core network. As another example, multi-mode base stations capable of simultaneously supporting different cellular communication technologies (e.g., 5G NR and LTE, LTE and CDMA 1xRTT, GSM and UMTS, or any other combination of cellular communication technologies) might be coupled to a core network that also supports the different cellular communication technologies. Any of various other network deployment scenarios are also possible.

As a further possibility, it is also possible that base station 102A and base station 102B may operate according to the same wireless communication technology (or an overlapping set of wireless communication technologies). For example, base station 102A and core network 100A may be operated by one cellular service provider independently of base station 102B and core network 100B, which may be operated by a different (e.g., competing) cellular service provider. Thus, in this case, despite utilizing similar and possibly compatible cellular communication technologies, the UE devices 106A-106N might communicate with the base stations 102A-102B independently, possibly by utilizing separate subscriber identities to communicate with different carriers' networks.

A UE 106 may be capable of communicating using multiple wireless communication standards. For example, a UE 106 might be configured to communicate using either or both of a 3GPP cellular communication standard (such as LTE) or a 3GPP2 cellular communication standard (such as a cellular communication standard in the CDMA2000 family of cellular communication standards). As another example, a UE 106 might be configured to communicate using different 3GPP cellular communication standards (such as two or more of GSM, UMTS, LTE, LTE-A, or 5G NR). Thus, as noted above, a UE 106 might be configured to communicate with base station 102A (and/or other base stations) according to a first cellular communication standard (e.g., 5G NR) and might also be configured to communicate with base station 102B (and/or other base stations) according to a second cellular communication standard (e.g., LTE).

Base stations 102A and 102B and other base stations operating according to the same or different cellular communication standards may support one or more networks of cells, which may provide continuous or nearly continuous overlapping service to UEs 106A-106N and similar devices over a wide geographic area via one or more cellular communication standards.

A UE 106 might also or alternatively be configured to communicate using WLAN, Bluetooth, one or more global navigational satellite systems (GNSS, e.g., GPS or GLONASS), one and/or more mobile television broadcasting standards (e.g., ATSC-M/H or DVB-H), etc. Other combinations of wireless communication standards (including more than two wireless communication standards) are also possible.

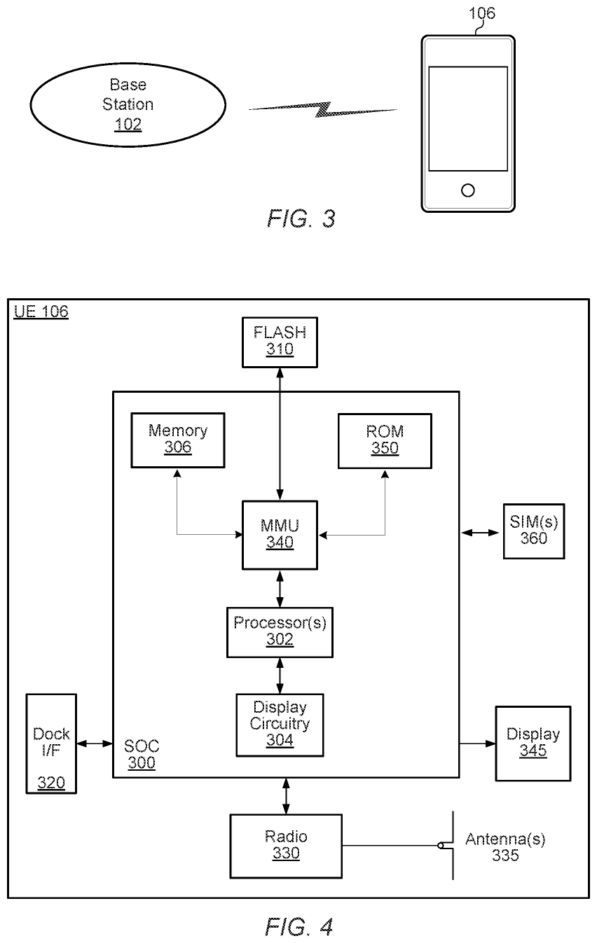

FIG. 3 illustrates user equipment 106 (e.g., one of the devices 106A through 106N) in communication with a base station 102 (e.g., one of the base stations 102A or 102B). The UE 106 may be a device with wireless network connectivity such as a mobile phone, a hand-held device, a satellite phone, a computer or a tablet, a wearable device or virtually any type of wireless device. The base station 102 may be part of a non-terrestrial network. For example, the base station 102 may be included in a non-terrestrial platform (NTP), which provides one or more cells for wireless communication with UEs. Alternatively, the base station 102 may be located on or near the earth's surface, and configured for wireless communication with one or more NTPs. An NTP may include a platform such as a satellite, a high-altitude platform (HAP), an unmanned aerial vehicle (UAV), etc.

The UE may include a processor that is configured to execute program instructions stored in memory. The UE may perform any of the method embodiments described herein by executing such stored instructions. Alternatively, or in addition, the UE may include a programmable hardware element such as an FPGA (field-programmable gate array) that is configured to perform any of the method embodiments described herein, or any portion of any of the method embodiments described herein.

The UE 106 may be configured to communicate using any of multiple wireless communication protocols. For example, the UE 106 may be configured to communicate using two or more of GSM, UMTS (W-CDMA, TD-SCDMA, etc.), CDMA2000 (1xRTT, 1xEV-DO, HRPD, eHRPD, etc.), LTE, LTE-A, 5G New Radio (NR), WLAN, or GNSS. Other combinations of wireless communication standards are also possible.

The UE 106 may include one or more antennas (or, one or more antenna arrays) for communicating using one or more wireless communication protocols. Within the UE 106, one or more parts of a receive and/or transmit chain may be shared between multiple wireless communication standards; for example, the UE 106 might be configured to communicate using either (or both) of LTE or 5G NR using a single shared radio. The shared radio may include a single antenna, or may include a plurality of antennas (e.g., for MIMO and/or beamforming) for performing wireless communications. (MIMO is an acronym for Multi-Input Multiple-Output.) The antennas may be organized in one or more arrays.

### FIG. 4—Example of Block Diagram of a UE

FIG. 4 illustrates an example of a block diagram of a UE 106. As shown, the UE 106 may include a system on chip (SOC) 300, which may include portions for various purposes. For example, as shown, the SOC 300 may include processor(s) 302 which may execute program instructions for the UE 106 and display circuitry 304 which may perform graphics processing and provide display signals to the display 345. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, radio 330, connector I/F 320, and/or display 345. The MMU 340 may be configured to perform memory protection and page table translation or set up. In some embodiments, the MMU 340 may be included as a portion of the processor(s) 302.

As shown, the SOC 300 may be coupled to various other circuits of the UE 106. For example, the UE 106 may include various types of memory (e.g., including Flash memory 310), a connector interface 320 (e.g., for coupling to a computer system, dock, charging station, etc.), the display 345, and radio 330.

The radio 330 may include one or more RF chains. Each RF chain may include a transmit chain, a receive chain, or both. For example, radio 330 may include two RF chains to support dual connectivity with two base stations (or two cells). The radio may be configured to support wireless communication according to one or more wireless communication standards, e.g., one or more of GSM, UMTS, LTE, LTE-A, 5G NR, WCDMA, CDMA2000, Bluetooth, Wi-Fi, GPS, etc.

The radio 330 couples to antenna subsystem 335, which includes one or more antennas. For example, the antenna subsystem 335 may include a plurality of antennas (e.g., organized in one or more arrays) to support applications such as dual connectivity or MIMO and/or beamforming. The antenna subsystem 335 transmits and receives radio signals to/from one or more base stations or devices through the radio propagation medium.

In some embodiments, the processor(s) 302 may include a baseband processor to generate uplink baseband signals and/or to process downlink baseband signals. The processor(s) 302 may be configured to perform data processing according to one or more wireless telecommunication standards, e.g., one or more of GSM, UMTS, LTE, LTE-A, 5G NR, WCDMA, CDMA2000, Bluetooth, Wi-Fi, GPS, etc.

The UE 106 may also include one or more user interface elements. The user interface elements may include any of various elements, such as display 345 (which may be a touchscreen display), a keyboard (which may be a discrete keyboard or may be implemented as part of a touchscreen display), a mouse, a microphone and/or speakers, one or more cameras, one or more sensors, one or more buttons, sliders, and/or dials, and/or any of various other elements capable of providing information to a user and/or receiving/interpreting user input.

As shown, the UE 106 may also include one or more subscriber identity modules (SIMs) 360. Each of the one or more SIMs may be implemented as an embedded SIM (eSIM), in which case the SIM may be implemented in device hardware and/or software. For example, in some embodiments, the UE 106 may include an embedded UICC (eUICC), e.g., a device which is built into the UE 106 and is not removable. The eUICC may be programmable, such that one or more eSIMs may be implemented on the eUICC. In other embodiments, the eSIM may be installed in UE 106 software, e.g., as program instructions stored on a memory medium (such as memory 306 or Flash 310) executing on a processor (such as processor 302) in the UE 106. As one example, a SIM 360 may be an application which executes on a Universal Integrated Circuit Card (UICC). Alternatively, or in addition, one or more of the SIMs 360 may be implemented as removable SIM cards.

The processor 302 of the UE device 106 may be configured to implement part or all of the methods described herein, e.g., by executing program instructions stored on a memory medium (e.g., a non-transitory computer-readable memory medium). In other embodiments, processor 302 may be configured as or include: a programmable hardware element, such as an FPGA (Field Programmable Gate Array); or an ASIC (Application Specific Integrated Circuit); or a combination thereof.

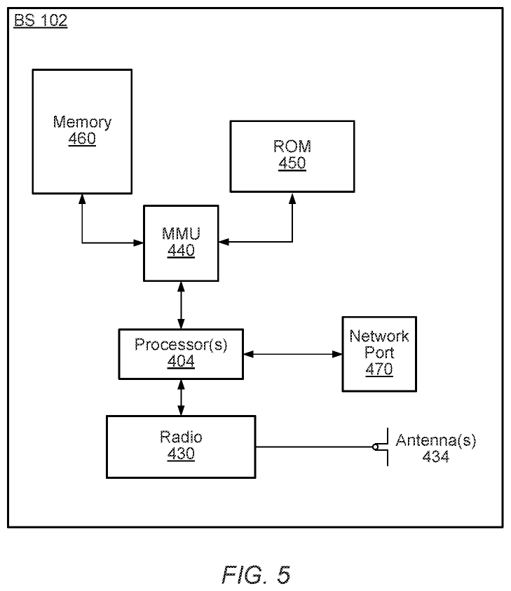

### FIG. 5—Example of a Base Station

FIG. 5 illustrates a block diagram of a base station 102. It is noted that the base station of FIG. 5 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory ROM 450) or to other circuits or devices.

The base station 102 may include at least one network port 470. The network port 470 may be configured to couple to a telephone network and provide access (for a plurality of devices, such as UE devices 106) to the telephone network, as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide telephony services (e.g., among UE devices served by the network provider).

The base station 102 may include a radio 430 having one or more RF chains. Each RF chain may include a transmit chain, a receive chain, or both. (For example, the base station 102 may include at least one RF chain per sector or cell.) The radio 430 couples to antenna subsystem 434, which includes one or more antennas, or one or more arrays of antennas. A plurality of antennas would be needed, e.g., to support applications such as MIMO and/or beamforming. The antenna subsystem 434 transmits and receives radio signals to/from UEs through the radio propagation medium.

In some embodiments, the processor(s) 404 may include a baseband processor to generate downlink baseband signals and/or to process uplink baseband signals. The baseband processor may be configured to operate according to one or more wireless telecommunication standards, including, but not limited to, GSM, LTE, 5G New Radio, WCDMA, CDMA2000, etc.

The processor(s) 404 of the base station 102 may be configured to implement any of the methods described herein, e.g., by executing program instructions stored on a memory medium (e.g., a non-transitory computer-readable memory medium). In some embodiments, the processor(s) 404 may include: a programmable hardware element, such as an FPGA (Field Programmable Gate Array); or an ASIC (Application Specific Integrated Circuit); or a combination thereof.

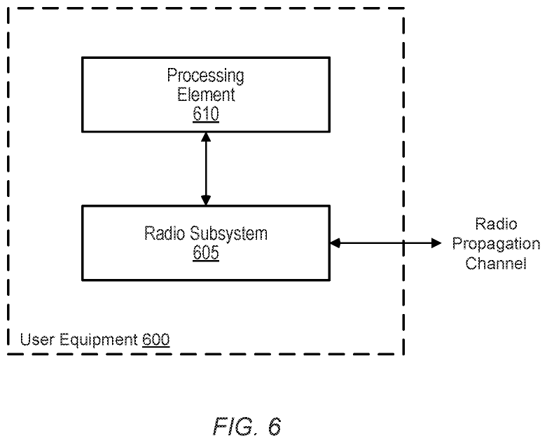

In some embodiments, a wireless user equipment (UE) device 600 may be configured as shown in FIG. 6. UE device 600 may include: a radio subsystem 605 for performing wireless communication; and a processing element 610 operatively coupled to the radio subsystem. (UE device 600 may also include any subset of the UE features described above, e.g., in connection with FIGS. 1-4.)

The radio subsystem 605 may include one or more RF chains, e.g., as variously described above. Each RF chain may be configured to receive signals from the radio propagation channel and/or transmit signals onto the radio propagation channel. Thus, each RF chain may include a transmit chain and/or a receive chain. The radio subsystem 605 may be coupled to one or more antennas (or, one or more arrays of antennas) to facilitate signal transmission and reception. Each transmit chain (or, some of the transmit chains) may be tunable to a desired frequency, thus allowing the transmit chain to transmit at different frequencies at different times. Similarly, each receive chain (or, some of the receive chains) may be tunable to a desired frequency, thus allowing the receive chain to receive at different frequencies at different times.

The processing element 610 may be coupled to the radio subsystem, and may be configured as variously described above. (For example, processing element may be realized by processor(s) 302.) The processing element may be configured to control the state of each RF chain in the radio subsystem. The processing element may be configured to perform any of the UE-based method embodiments described herein.

In some embodiments, the processing element may include one or more baseband processors to (a) generate baseband signals to be transmitted by the radio subsystem and/or (b) process baseband signals provided by the radio subsystem.

In a dual connectivity mode of operation, the processing element may direct a first RF chain to communicate with a first base station using a first radio access technology and direct a second RF chain to communicate with a second base station using a second radio access technology. For example, the first RF chain may communicate with an LTE eNB, and the second RF chain may communicate with a gNB of 5G New Radio (NR). The link with the LTE eNB may be referred to as the LTE branch. The link with the gNB may be referred to as the NR branch. In some embodiments, the processing element may include a first subcircuit for baseband processing with respect to the LTE branch and a second subcircuit for baseband processing with respect to the NR branch.

The processing element 610 may be further configured as variously described in the sections below.

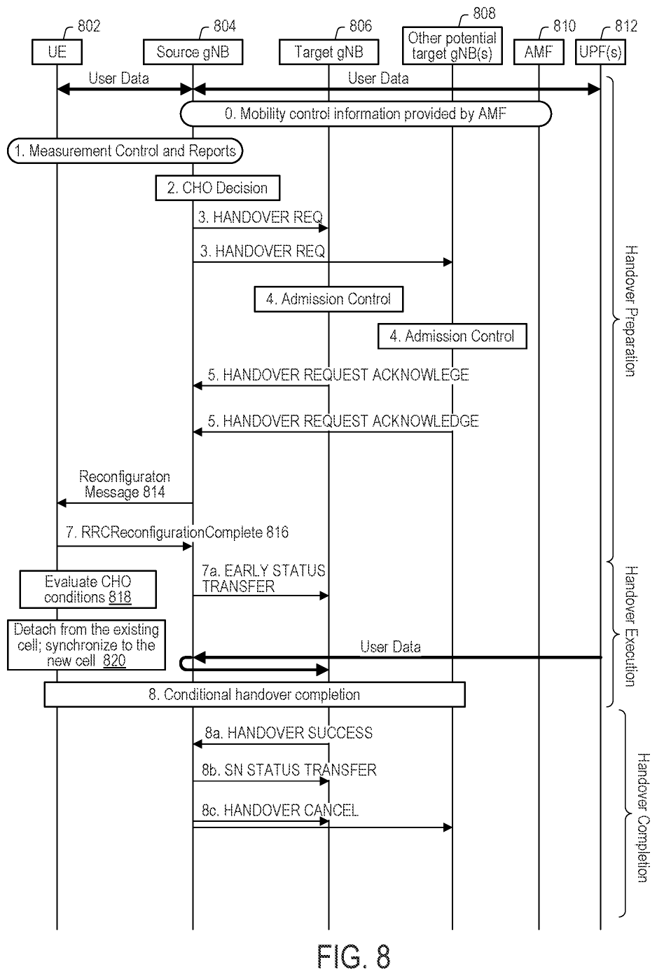

The UE device 600 may include memory (e.g., any of the memories described above in connection with user equipment 106 of FIG. 6, or any combination of those memories) that stores program instructions to implement any of the UE method embodiments described herein, e.g., program instructions to be executed by the processing element 610. In some embodiments, the memory may store program instructions to receive and process the reconfiguration message 814 of FIG. 8, e.g., as variously described herein.

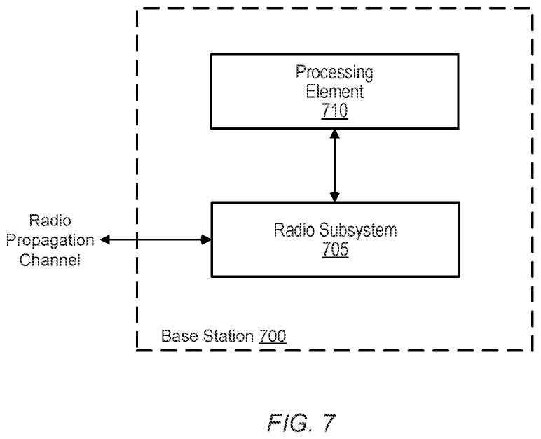

In some embodiments, a wireless base station 700 of a wireless network (not shown) may be configured as shown in FIG. 7. The wireless base station may include: a radio subsystem 705 for performing wireless communication over a radio propagation channel; and a processing element 710 operatively coupled to the radio subsystem. (The wireless base station may also include any subset of the base station features described above, e.g., the features described above in connection with FIG. 5.) The wireless base station may host one or more cells. For example, in the context of a non-terrestrial network, the wireless base station may be included in a non-terrestrial platform such as a satellite, or HAP, or UAV, or aircraft. Alternatively, the wireless base station may be situated on or near the earth's surface, and configured for wireless communication with one or more NTPs, each of which mediates a corresponding set of one or more cells.

The radio subsystem 705 may include one or more RF chains. Each transmit/receive chain may be tunable to a desired frequency, thus allowing the transmit/receive chain to transmit/receive at different frequencies at different times. The radio subsystem 705 may be coupled to an antenna subsystem, including one or more antennas, e.g., an array of antennas, or a plurality of antenna arrays. The radio subsystem may employ the antenna subsystem to transmit and receive radio signals to/from the radio wave propagation medium.

The processing element 710 may be realized as variously described above. For example, in one embodiment, processing element 710 may be realized by processor(s) 404. In some embodiments, the processing element may include one or more baseband processors to: (a) generate baseband signals to be transmitted by the radio subsystem, and/or, (b) process baseband signals provided by the radio subsystem.

The processing element 710 may be configured to perform any of the base station method embodiments described herein.

The base station 700 may include memory (e.g., memory 460 of base station 102 of FIG. 5, or some other memory) that stores program instructions to implement any of the base station method embodiments described herein, e.g., program instructions to be executed by the processing element 710. In some embodiments, the memory may store program instructions to compose and transmit the reconfiguration message 814 of FIG. 8, e.g., as variously described herein.

### Conditional Handover for Non-Terrestrial Networks

A user equipment (UE) may communicate with cells of a non-terrestrial network (NTN). For example, the UE may communicate with cells generated by one or more non-terrestrial platforms such as satellites, unmanned aerial vehicles (UAVs), high altitude platforms (HAPs), aircraft, etc. The base stations hosting the cells may be based on earth and/or on the non-terrestrial platforms. Thus, in some embodiments, a non-terrestrial platform may: receive data from an earth-based base station and forward the data to an earth-based UE via downlink transmission; and receive data from the UE via uplink transmission and forward the data to the earth-based base station. (It should be noted the term “earth-based”, when used of an entity, does not require that entity to be fixed. For example, an earth-based base station may be situated on a train or ship.) In other embodiments, where a base station is included as part of the non-terrestrial platform, the non-terrestrial platform may receive data from an earth-based network node of the communication network, and forward the data to the UE via downlink transmission; and receive data from the UE, and forward the data to earth-based network node.

In some embodiments, the UE may be on or near the earth's surface. In other embodiments, the UE may be located above the earth's surface, e.g., on an aircraft or high altitude platform (HAP).

The coverage area of each cell may move on the surface of the earth. Thus, even if the UE is not moving, the UE will enter and exit the coverage areas of different cells at different times. Thus, the UE will need to execute a handover from a first cell to a second cell when it is leaving the coverage area of the first cell. The UE may be configured to execute a conditional handover from one cell to another in response to a determination that one or more network-configured conditions are satisfied.

In some embodiments, a non-terrestrial platform may include one or more antenna arrays to facilitate uplink and/or downlink beamforming. A non-terrestrial platform may include one or more arrays of solar cells to power operations of the NTP, and batteries to store the power produced by the solar cell(s). A non-terrestrial platform such as a satellite may include mechanisms to adjust its attitude and/or position.

In some embodiments, elements in a non-terrestrial network may perform a conditional handover procedure, e.g., as shown in FIG. 8. A user equipment (UE) 802 may be communicating user data to/from a source gNB 804, and the source gNB may be communicating user data to/from one or more user plane functions (UPFs) 812. At step 0, mobility control information may be provided by an access and mobility management function (AMF) 810. The mobility control information may be provided to the source gNB, e.g., using the restrictionType attribute of an ALLOWED_AREAS field. At step 1, the source gNB may configure measurement procedures to be implemented by the UE; and the UE may report the results of measurements to the source gNB, according to the measurement configuration. At step 2, the source gNB may decide to employ conditional handover (CHO). As the source gNB may not be able to predict which other gNB will be selected by the UE for the conditional handover, the source gNB may prepare a plurality of candidate gNBs for the conditional handover.

At step 3, the source gNB may send requests for conditional handover (HANDOVER REQUESTs) to one or more candidate cells associated with one or more candidate gNBs. The candidate gNBs are depicted as including a target gNB 806 and one or more other potential target gNBs 808. Each candidate gNB may perform a step 4 of admission control (e.g., as described in 3GPP TS 38.300), in response to which, the candidate gNB may send an acknowledgement (referred to as HANDOVER REQUEST ACKNOWLEDGE) of the conditional handover request to the source gNB. At step 5, the acknowledgement sent by a candidate gNB may include configuration of one or more CHO candidate cells associated with (or mediated by) the candidate gNB. In some embodiments, one acknowledgement message may be sent for each candidate cell.

In response to receiving the acknowledgements, the source gNB may transmit a reconfiguration message 814, e.g., a reconfiguration message of the RRC protocol, to the UE. (RRC is an acronym for Radio Resource Control.) The reconfiguration message may include a reconfiguration measurement index. The contents of the reconfiguration message and the reconfiguration measurement index may be different in different embodiments. The reconfiguration message may include configuration of the CHO candidate cells(s) of the candidate gNBs, and corresponding conditions for CHO execution.

In response to receiving the reconfiguration message (including the reconfiguration measurement index), the UE may transmit a reconfiguration complete message 816, e.g., using the RRC protocol. In response to receiving the reconfiguration complete message, the source gNB may transmit an early status transfer message (at step 7a) to the target gNB 806 and/or to the other potential target gNB(s) 808, e.g., if early data forwarding is to be applied. (The UE may be configured to evaluate the CHO condition(s) for the target gNB prior to evaluating the CHO condition(s) for the other potential target gNB(s).) After transmitting the early status transfer message, the source gNB may forward user data from the UPF(s) to the target gNB (and/or the other potential gNB(s)).

After receiving the reconfiguration message, the UE may maintain the current connection with the source gNB, and evaluate one or more conditional handover conditions for each of the candidate cells, as shown at 818. (The one or more CHO conditions may be indicated or defined by the reconfiguration message and/or the reconfiguration measurement index.) In response to determining that one of the candidate cells satisfies the corresponding condition for CHO, the UE may designate the determined candidate cell as the target cell, detach from the existing cell, apply the corresponding stored configuration for the target cell, and synchronize to the target cell, as indicated at 820. In FIG. 8, the target cell is assumed to be a cell of target gNB 806. Though the target cell is typically a single candidate, for latency purposes, the target cell could be associated with any of the candidate gNBs, e.g., one of the potential target gNB(s) 808.

At step 8, the conditional handover is completed. For example, the UE may complete the conditional handover procedure by sending a reconfiguration complete message (not shown) to the target gNB, e.g., an RRC reconfiguration complete message.

At step 8a, the target gNB may send a handover success message to the source gNB, to notify the source gNB that the UE has successfully accessed the target cell. At step 8b, the source gNB may send an SN status transfer message to the target gNB. (SN is an acronym for Source/Secondary Node. For example, in the present context, the source gNB is the SN.) At step 8c, the target gNB may send a handover cancel message to the target gNB 806 and the other potential target gNB(s). After the SN status transfer or the handover cancel message, the target gNB may receive user data from the network, and forward the user data to the UE; and receive user data from the UE, and forward the user data to the network.

If the evaluation 818 of the one or more CHO conditions fails, the source gNB may forward user data to the other potential gNB(s) 808, and execute a new handover (e.g., a conditional handover) to one of the other potential target gNB(s).

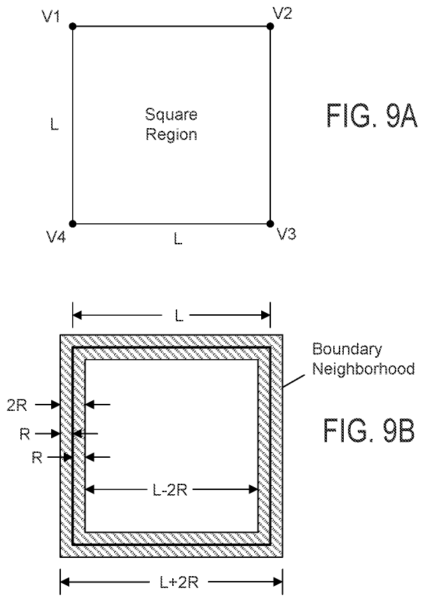

In various embodiments, one or more of the steps shown in FIG. 8 may be omitted and/or performed in an order different from that shown. Furthermore, one or more steps may be added. For example, in some embodiments, step 9-12 of FIG. 9.2.3.2.1-1 of 3GPP TS 38.300 may be added, e.g., after the step 8c. (TS is an acronym for Technical Specification.)

### Location Based Conditional Handover

In some embodiments, the UE may perform a location based conditional handover between NTN cells as follows. A non-terrestrial platform (NTP) may transmit region information to the UE. (For example, an NTP corresponding to the current serving cell may transmit the region information.) The region information indicates or defines a region for a current serving cell, i.e., a region on the surface of the earth. (The term “surface of the earth” is to be interpreted broadly, and include the land surface and lake/sea/ocean surface.) The region may be a coverage area of the serving cell or a portion of the coverage area of the serving cell. (More generally, the region information may define regions or areas of coverage for one or more cells, e.g., cells known by the network to be presently near the UE's location.) The region information may include coordinates (e.g., GNSS coordinates) for the vertices of a polygon on the earth's surface. GNSS is an acronym for global navigation satellite system. For example, the region information may include GNSS coordinates for the vertices V1-V4 of a square, as shown in FIG. 9A. The polygon may be a rectangle, a pentagon, a hexagon, or an N-gon with N greater than or equal to three. (The term “N-gon” refers to refers to a polygon with N sides.) The polygon may correspond to the cell coverage area (or a portion of the cell coverage area) at a particular time, e.g., the current time or a future time. The NTP may send updates of the region information to the UE over time.

The NTP may also transmit a size parameter along with the region information. The size parameter may indicate the width or radius of a neighborhood of the boundary polygon of the region. For example, in the case of the square region of FIG. 9A, the size parameter may indicate the radius R of a neighborhood that includes the boundary square. Thus, if the boundary square has side length L, the neighborhood of the boundary square may be interpreted as the region (shown in crosshatch) bounded by a square of side length L+2R and a square of side length L−2R, as shown in FIG. 9B, both having the same center as the square of side length L.

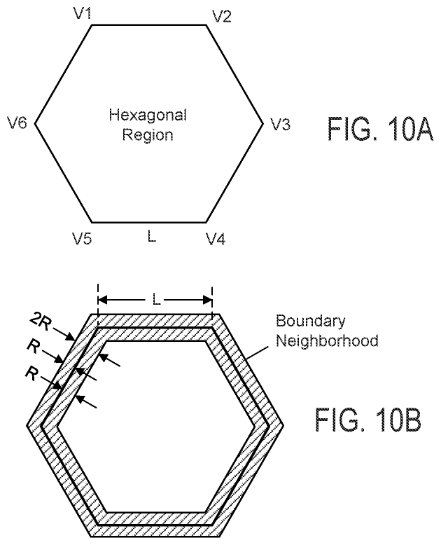

As another example, in the case of a hexagonal region, the region information may include vertices V1-V6, as shown in FIG. 10A. The size parameter may define a neighborhood of radius R (or width 2R) that includes the hexagonal boundary of the region. (While the boundary hexagon is depicted as being a regular hexagon, non-regular hexagons may be used just as well.) As shown in FIG. 10B, the neighborhood, shown in crosshatch, may be the set of points on the earth's surface whose distance from the hexagonal boundary is less than (or, less than or equal to) R.

In some embodiments, the UE may employ a GPS receiver to determine its current location. The UE may then determine whether the current location is within the neighborhood of the boundary. If the current location is within the neighborhood, the UE may determine whether one or more additional CHO conditions are satisfied. The one or more additional CHO conditions may include one or more conditions based on signal quality such as RSRP or RSRQ of one or more potential target cells (or candidate cells). (The one or more additional CHO conditions may include one or more conditions defined by a wireless standard, such as 3GPP NR or LTE.) The network may indicate one or more thresholds to be used in conjunction with testing the one or more signal quality conditions. For example, the RSRP or RSRQ of a reference signal transmitted by a potential target cell, may be required to be greater than a threshold, in order to execute a handover to that cell.

In some embodiments, the region information and the size parameter may be included in a CHO configuration and/or a CHO measurement trigger transmitted by the network to the UE via a non-terrestrial platform (NTP). In some embodiments, the region information may be realized as GNSS coordinates, and the size parameter may be realized as a GPS accuracy.

In some embodiments, new fields may be introduced in a CHO report configuration of 3GPP 5GNR and/or a CHO measurement trigger of 3GPP 5GNR, to convey the GNSS coordinates and/or the GPS accuracy to the UE.

In some embodiments, the GNSS coordinates and/or the GPS accuracy may be included in the reconfiguration message 814 (e.g., in the RRCReconfiguration measurement index of the reconfiguration message) of FIG. 8.

In some embodiments, the actual format of the GNSS coordinates can be similar to the Geographical Area Co-ordinates IE or the Warning Area Coordinates IE from SIB8 of 3GPP TS 38.331. (IE is an acronym for Information Element.) The GNSS coordinates may indicate a polygon of the area where the CHO is applicable.

Upon reception of the GNSS coordinates and the GPS accuracy, the UE may evaluate the location-based CHO condition as described above. If the location-based condition is satisfied, the one or more additional CHO conditions may be evaluated. If the one or more additional CHO conditions are satisfied, the UE may start the procedure to handover to the target cell.

In some embodiments, the UE may apply a location-based condition to a candidate cell (i.e., a potential target cell) before designating the candidate cell as a target cell for conditional handover. For example, the UE may receive region information for the candidate cell, e.g., from the currently serving satellite. The region information may indicate or specify a region for the potential target cell. For example, the region may be an area of coverage of the candidate cell or a portion of that area of coverage. (Optionally, the UE may also receive a size parameter for the candidate cell, where the size parameter determines a radius R for a neighborhood of the boundary of the region.) If the UE determines that the UE's current GPS location is within the region (or alternatively, within the radius R neighborhood of the boundary of the region) the UE may select the candidate cell as the target cell for handover, or may test one or more additional CHO conditions to determine whether to execute a conditional handover to the candidate cell.

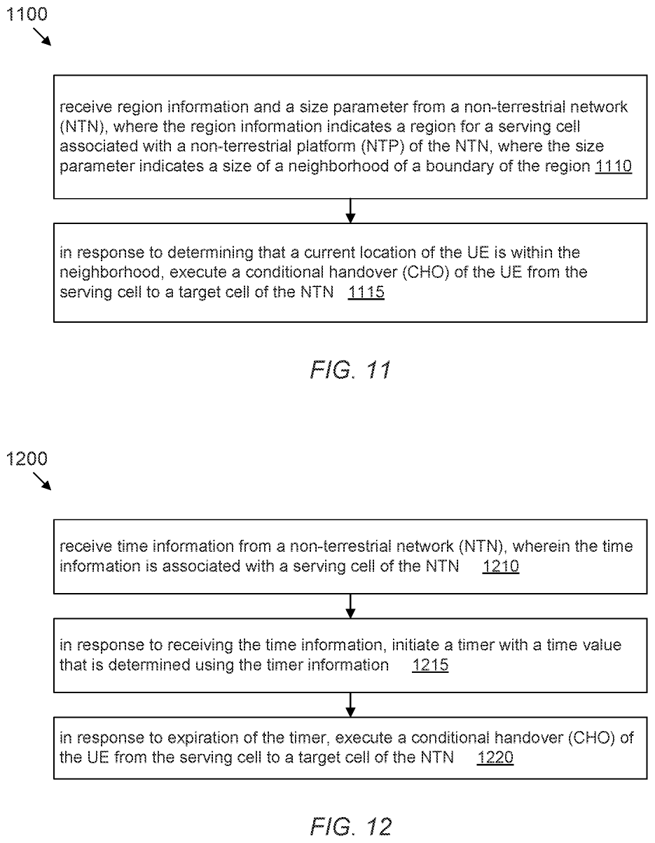

In one set of embodiments, a method 1100 for operating an apparatus may include the operations shown in FIG. 11. (The method 1100 may also include any subset of the features, elements or operations described above in connection with FIGS. 1-10B, and described below in connection with FIGS. 12-15.) The method 1100 may be performed by processing circuitry, e.g., by the processing element 610 of user equipment 600.

At 1110, the processing circuitry may receive region information and a size parameter from a non-terrestrial network (NTN), e.g., from a base station of the NTN. The region information may indicate a region for a serving cell associated with a non-terrestrial platform (NTP) of the NTN. For example, the region may be (or include) a coverage area of the serving cell or a portion of the coverage area of the serving cell. The size parameter may indicate a size of a neighborhood of a boundary of the region, e.g., as variously described above. For example, the size parameter may indicate a radius R for the neighborhood, where the neighborhood is defined as the set of points whose distance from the boundary of the region is less than R.

At 1115, in response to determining that a current location of the UE is within the neighborhood, the processing circuitry may execute (or initiate) a conditional handover (CHO) of the UE from the serving cell to a target cell of the NTN.

In some embodiments, the base station may reside on the earth, and send the region information and the size parameter to the UE via an NTP, e.g., the NTP associated with the serving cell. Alternatively, the base station may be located in the NTP. In the context of 3GPP SGNR, the base station may be a gNB.

In some embodiments, the action of executing the conditional handover may include testing one or more additional CHO conditions, e.g., as variously described above.

In some embodiments, the NTP is a satellite or a high altitude platform (HAP) or an aircraft or a space vehicle or a moon-based transceiver station.

In some embodiments, the region information and the size parameter may be received as part of a reconfiguration message of a radio resource control (RRC) protocol.

In some embodiments, the region information and the size parameter may be received as part of a measurement index of the reconfiguration message, as described above.

In some embodiments, the processing circuitry may receive additional region information and an additional size parameter for the target cell of the NTN, where the additional region information indicates an additional region, for the target cell, and the additional size parameter indicates a size of an additional neighborhood, that includes a boundary of the additional region. The action of executing the conditional handover to the target cell may be further conditioned upon the current location of the UE being within the additional neighborhood, e.g., as described above.

In some embodiments, the UE may include a GPS receiver, wherein the GPS receiver is configured to determine the current location of the UE in response to a request from the processing circuitry.

In some embodiments, the action of executing the conditional handover includes testing a condition on signal quality of the target cell.

In some embodiments, the UE may include: an RF transceiver; and an antenna array coupled to the RF transceiver.

In one set of embodiments, a method for operating an apparatus may include the following operations. (The method may also include any subset of the features, elements or operations described above in connection with FIGS. 1-11, and described below in connection with FIGS. 12-15.) The method may be performed by processing circuitry, e.g., by the processing element 610 of user equipment 600. The processing circuitry may receive region information from a non-terrestrial network (NTN), e.g., from a base station of the NTN. The region information may indicate a subregion of an area of coverage for a serving cell associated with a non-terrestrial platform (NTP) of the NTN. In response to determining that a current location of the UE is within the subregion, the processing circuitry may execute (or initiate) a conditional handover (CHO) of the UE from the serving cell to a target cell of the NTN. The network may assign different subregions to different UEs (or different subsets of UEs) served by the serving cell, to spread a load of CHO processing.

In one set of embodiments, a method for operating an apparatus may include the following operations. (The method may also include any subset of the features, elements or operations described above in connection with FIGS. 1-11, and described below in connection with FIGS. 12-15.) The method may be performed by processing circuitry, e.g., by the processing element 610 of user equipment 600. The processing circuitry may receive region information from a non-terrestrial network (NTN), e.g., from a base station of the NTN. The region information may indicate a subregion of an area of coverage for a potential target cell associated with a non-terrestrial platform (NTP) of the NTN. In response to determining that a current location of the UE is within the subregion, the processing circuitry may execute (or initiate) a conditional handover (CHO) of the UE from a serving cell to the potential target cell of the NTN. The network may assign different subregions to different UEs (or different subsets of UEs) served by the serving cell, to spread a load of CHO processing.

In some embodiments, a method for operating a serving base station may include the following operations, to facilitate a conditional handover of a user equipment (UE) from a serving cell of a serving base station. (The method may also include any subset of the features, elements or operations described above in connection with FIGS. 1-11, and described below in connection with FIGS. 12-15.) The method may be performed by processing circuitry, e.g., by the processing element 710 of base station 700. In response to receiving a conditional handover acknowledgement, e.g., as described above in connection with FIG. 8, the processing circuitry may transmit a reconfiguration message including region information and a size parameter, to a user equipment (UE) served by the serving cell. The region information may indicate a region corresponding to a non-terrestrial platform (NTP) of a non-terrestrial network (NTN), e.g., an NTP used by the serving base station to mediate the serving cell. For example, the region may correspond to a coverage area or a portion of the coverage area of the NTP. The size parameter may indicate a size (or radius) of a neighborhood of a boundary of the region.

Furthermore, in response to receiving a reconfiguration complete message from the UE, the processing circuitry may transmit an early status transfer message to a target base station of the conditional handover, and start forwarding user data to the target base station. In response to an indication that conditional handover of the UE to the target base station is complete, the processing circuitry may transmit a handover success message to the target base station.

In some embodiments, the processing circuity may configure different UEs (or different subsets of UEs) with different regions of the coverage area of the serving cell, to spread the load of CHO processing.

### Power Consumption of Location-Based Handover

Because the location-based conditional handover procedure may require repeated (e.g., frequent) transmissions of the cell coverage information and size parameter from the network, and repeated testing of the location-based CHO condition, until it is satisfied, the location-based CHO procedure may consume power at a rate that is deemed to be excessive in some circumstances. Thus, the present disclosure explores other possible solutions for conditional handover in an NTN network.

### Timer Based Conditional Handover

In some embodiments, the UE may perform a timer-based condition handover (CHO). The network (e.g., a base station of the network) may transmit a timer value to the UE via a non-terrestrial platform (NTP). (For example, an NTP corresponding to the current serving cell may transmit or forward the timer value to the UE.) The timer value may indicate an amount of time the UE is to wait before testing one or more additional CHO conditions. (The timer value may be indicated from a standardized list or a configured list of possible values.) The timer value may, e.g., represent an amount of time the UE is guaranteed to be within the coverage area of a current serving cell.

In response to receiving the timer value, the UE may initiate a timer (e.g., a counter device) based on the timer value. When the timer expires (i.e., when the timer has finished counting out the indicated amount of time), the UE may test the one or more additional CHO conditions. As described above, the one or more additional CHO conditions may include one or more conditions based on signal quality such as RSRP or RSRQ. In response to determining that the one or more additional CHO conditions are satisfied, the UE may execute a handover to a target cell, e.g., a cell associated with a different satellite.

In some embodiments, the timer configuration (e.g., the timer value) can be provided by the network based on ephemeris data, e.g., ephemeris data for a satellite that mediates or hosts the currently serving cell.

In some embodiments, the timer value has a magnitude that is on the order of seconds. However, a wide variety of magnitude ranges are possible in varying circumstances and network deployments.

In some embodiments, the reconfiguration message 814 of FIG. 8 (e.g, in the reconfiguration measurement index of the reconfiguration message) may include the timer value. For example, the reconfiguration measurement index may include a timer field (referred to herein as “UponTimerExpiry”) to carry the timer value.

In some embodiments, the network may provide ephemeris data to the UE, e.g., ephemeris data for a satellite that mediates or hosts the currently serving cell. The UE may apply the CHO configuration frequently, to check whether the one or more CHO criteria defined by the CHO configuration are satisfied.

In some embodiments, the timer may count clock ticks or absoluteTime.

In some embodiments, the network may transmit (to the UE, e.g., via the currently serving satellite) a timer value corresponding to a potential target cell. The timer value may represent an amount of time the UE is to wait before considering the possibility of a conditional handover to the potential target cell. In some instances, the network may be able to predict the amount of time until the UE's entry into the coverage area of the potential target cell and provide an appropriate timer value accordingly. Furthermore, the network may assign different timer values to different UEs to spread out the load of handovers to the potential target cell. In response to receiving the timer value, the UE may initiate a timer based on the timer value. When the timer expires (i.e., finishes counting out the amount of time defined by the timer value), the UE may test one or more additional CHO conditions. The one or more additional CHO conditions may include, e.g., a signal quality condition on the RF signal of the potential target cell. For example, the signal quality of a reference signal of the potential target cell may be required to be greater than a network-configured threshold, to enable handover to the potential target cell.

### Timer Based CHO with Time Range

In some embodiments, the UE may perform a timer-based conditional handover (CHO) using a network-provided time range. The network (e.g., a base station of the network) may transmit time range information to the UE via a non-terrestrial platform (NTP), e.g., a non-terrestrial platform that hosts or mediates the currently serving cell. The time range information may indicate time values t1 and t2 that define a time range [t1,t2] over which the non-terrestrial platform is to be visible to the UE, or in which the UE may execute (or initiate) a conditional handover. The network may provide different time ranges to different subsets of UEs, to spread over time the load of conditional handover processing for UEs within the cell.

In response to receiving the time range information, the UE may select (e.g., randomly select) a value T in the time range [t1,t2], and initiate a timer based on the selected value T. In response to expiration of the timer, the UE may test one or more additional CHO conditions. As described above, the one or more additional CHO conditions may include one or more conditions based on signal quality, such as RSRP or RSRQ. In response to determining that the one or more additional CHO conditions are satisfied, the UE may execute a handover to a target cell, e.g., a cell associated with a different NTP.

In some embodiments, the network may transmit a random seed to the UE along with the time range information. The UE may use the random seed to randomize its selection of the value T in the time range [t1,t2]. The randomization of the selection of the value T serves to spread over time the processing load of conditional handovers for UEs that receive the same time range [t1,t2]. The UE may employ one or more randomization techniques in addition to use of the random seed, for selection of the value T. Thus, even if different UEs receive the same time range [t1,t2] and the same random seed, they may nevertheless select different values of time T.

In some embodiments, the reconfiguration message 814 of FIG. 8 (e.g., in the reconfiguration measurement index of the reconfiguration message) may include the time range information and/or the random seed.

In some embodiments, the network may transmit time range information for a potential target cell. The time range information indicates a time range [t1,t2] corresponding to the potential target cell. The network may assign different time ranges to different subsets of UEs to spread out the load of handovers to the potential target cell. In response to receiving the time range information, the UE may select (e.g., randomly select) a time value Tin the time range [t1,t2], and initiate a timer with the time value T. When the timer expires, the UE may consider the possibility of handover to the potential target cell, e.g., by testing one or more (network-configured) additional CHO conditions. The one or more additional CHO conditions may include a condition on the RF signal quality of the potential target cell. For example, the UE may determine whether the RF signal quality (e.g., RSRP or RSRQ) of a reference signal transmitted by the potential target cell is greater than a threshold. If the one or more additional CHO conditions are satisfied, the UE may designate the potential target cell as the target cell for handover, and execute a handover to the target cell. Furthermore, the network may provide a random seed along with the timer range information, to enable the UE randomize its selection of the time value T.

### RNTI Based Randomization of Time Value Selection

As discussed above, the network may provide time range information (including time values t1 and t2) and a random seed. In some embodiments, as an alternative to supplying the random seed, the network may provide a UE-specific random value to the UE. The network may determine the UE-specific random value by selecting (e.g., randomly selecting) a value V₀, and computing the UE-specific random value V_{UE} according to the relation

V_{UE}=V₀ mod CRNTI_{UE},

where “mod” denotes the modulus operation, and CRNTI_{UE} is the unique Cell Radio Network Temporary Identifier that has been assigned to the UE. The network or base station may assign different CRNTI values to different UEs in a cell. The base station may use CRNTI to allocate uplink grants, downlink assignments, etc., to the UE. Furthermore, CRNTI may be used by the base station to differentiate uplink transmissions such as PUSCH and PUCCH from different UEs.

In response to receiving the time range information and the UE-specific random value V_{UE}, the UE may deterministically select a time value T within the range [t1,t2], using the value V_{UE}. The UE may then initiate the timer based on the time value T, and proceed as described above.

In some embodiments, the base station may transmit a UE-specific random value V_{UE} to the UE in the reconfiguration message 814 of FIG. 8 (e.g., in the reconfiguration measurement index of the reconfiguration message), along with the time range information.

Alternatively, the network may transmit the selected value Vo to the UE (instead of the UE-specific random value V_{UE}), and the UE may compute the UE-specific random value V_{UE} according to the relation

V_{UE}=V₀ mod CRNTI_{UE}.

The network may assign the value CRNTI_{UE} to the UE when the UE transitions from idle mode to connected mode.

In some embodiments, the network may transmit (to the UE) time range information indicating a time range [t1,t2] for a potential target cell, along with a UE-specific random value V_{UE}. The UE may employ a timer to impose a wait time T, selected from the time range [t1,t2] as described above. The UE-specific random value V_{UE} may be employed by the UE to randomize the selection of the wait time T. During the wait time, the UE does not consider handover to the potential target cell. When the timer expires (after having counted out the wait time T), the UE may test one or more additional CHO conditions. The one or more additional CHO conditions may include a condition on the RF signal quality of the potential target cell. If the one or more additional CHO conditions are satisfied, the UE may execute (or initiate) a handover to the potential target cell.

### FIG. 12—Time Based Conditional Handover

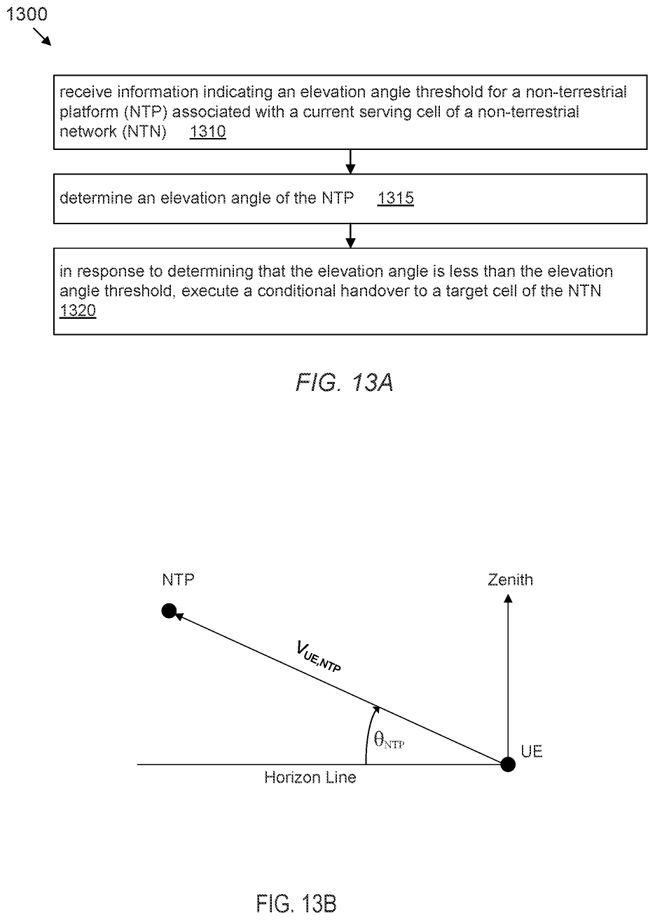

In one set of embodiments, a method 1200 for operating an apparatus may include the operations shown in FIG. 12. The method 1200 may also include any subset of the features, elements or operations described above in connection with FIGS. 1-11, and described below in connection with FIGS. 13-15. The method 1200 may be performed by processing circuitry, e.g., by the processing element 610 of user equipment 600.

At 1210, the processing circuitry may receive time information from a non-terrestrial network (NTN), e.g., from a base station of the NTN. The time information is associated with a serving cell of the NTN. The serving cell may be mediated by a non-terrestrial platform (NTP) such as a satellite, a high altitude platform (HAP), or UAV, or an aircraft.

At 1210, in response to receiving the time information, the processing circuitry may initiate a timer with a time value that is determined using the time information. The timer may count ticks of a clock residing in the UE. In one embodiment, the timer may include a counter device that decrements in response to ticks of the clock, and a comparator that determines when the value of the counter device has reached zero. However, it should be understood that there are a wide variety of ways to realize a timer in circuitry.

At 1210, in response to expiration of the timer, the processing circuitry may execute a conditional handover (CHO) of the UE from the serving cell to a target cell of the NTN, e.g., as variously described above.

In some embodiments, the base station may reside on the earth, and send the time information to the UE via an NTP, e.g., the NTP associated with the serving cell. Alternatively, the base station may be located in the NTP. In the context of 3GPP SGNR, the base station may be a gNB.

In some embodiments, the time information may include an indication of the time value. For example, the time information may indicate the time value from a standardized list of possible values or a network configured list of possible values.

In some embodiments, the time information may include a random seed and an indication of a time range. The time value of action 1210 may be randomly selected from the timer range based on the random seed, e.g., as described above.

In some embodiments, the time information may include: a UE-specific random value; and an indication of a time range, wherein the time value is selected from the time range using the UE specific random value.

In some embodiments, the serving cell may be mediated by a satellite or high altitude platform (HAP) of the NTN.

In some embodiments, the time information is received as part of a reconfiguration message of the radio resource control (RRC) protocol, e.g., as variously described above.

In some embodiments, the action of executing the conditional handover may include determining validity of one or more additional CHO conditions, e.g., as variously described above.

In some embodiments, the action of executing the conditional handover may include verifying a validity of a condition on signal quality of the target cell.

In some embodiments, a method for operating a serving base station may include the following operations, to facilitate a conditional handover of a user equipment (UE) from a serving cell of a serving base station. The method may also include any subset of the features, elements or operations described above in connection with FIGS. 1-12, and described below in connection with FIGS. 13-15. The method may be performed by processing circuitry, e.g., by the processing element 710 of base station 700. In response to receiving a conditional handover acknowledgement, e.g., as described above in connection with FIG. 8, the processing circuitry may transmit a reconfiguration message including time information to a user equipment (UE) served by the serving cell. The time information may direct the UE to impose a wait time before initiating a conditional handover from the serving base station (or the serving cell).

In response to receiving a reconfiguration complete message from the UE, the processing circuitry may transmit an early status transfer message to a target base station of the conditional handover, and start forwarding user data to the target base station. In response to an indication that the conditional handover of the UE to the target base station is complete, transmit a handover success message to the target base station.

In some embodiments, the time information includes an indication of the wait time. The serving base station may assign different wait times to different UEs (or different subsets of UEs), to spread out the load of CHO processing.

In some embodiments, the time information includes a random seed and an indication of a time range, where the wait time is randomly selectable (by the UE) from the timer range, based on the random seed. The serving base station may assign different time ranges to different UEs (or different subsets of UEs), to spread out the load of CHO processing.

In some embodiments, the time information includes: a UE specific random value; and an indication of a time range, where the time value is selectable (by the UE) from the time range, based on the UE specific random value. The serving base station may assign different time ranges to different UEs (or different subsets of UEs), to spread out the load of CHO processing.

### Elevation Angle Based Conditional Handover

In some embodiments, the UE may perform conditional handover (CHO) based on elevation angle of a satellite, e.g., a satellite that corresponds to the current serving cell. The network (e.g., a base station of the network) may transmit ephemeris data of the satellite to the UE, e.g., via the satellite. Each satellite may periodically broadcast ephemeris data that can be used by a UE to determine the satellite's position over a window in time. Ephemeris data may include one of more of the following: orbital parameters, clock correction coefficients, data age, satellite accuracy, week number. The UE may employ the ephemeris data to compute a current position of the satellite relative to the earth, and employ a GPS receiver to determine the UE's GPS location. The UE may then determine (using trigonometric calculations) the elevation angle of the satellite at the current time based on the computed satellite position and the UE's GPS location. (The satellite is an example of a non-terrestrial platform. FIG. 13B illustrates the definition of the elevation angle θ_{NTP} of a non-terrestrial platform (NTP), relative to a horizon line, according to some embodiments.) This calculation of the satellite's elevation angle may take into account the spherical nature of the earth's surface. The UE may compare the satellite's elevation angle θ_{S} to a network-provided threshold θ_{CHO}. If the satellite's elevation angle θ_{S} is less than the threshold θ_{CHO}, the UE may test one or more additional CHO conditions, e.g., as variously described above. For example, the one or more additional CHO conditions may include one or more conditions relating to signal quality. If the one or more additional CHO conditions are satisfied, the UE may execute a handover to a target cell, i.e., a cell mediated or hosted by a different satellite.

In some embodiments, the base station may indicate the elevation angle threshold θ_{CHO} to the UE, e.g., in a configuration message. For example, the threshold θ_{CHO} may be provided to the UE in the reconfiguration message 814 of FIG. 8 (e.g., in the reconfiguration measurement index of the reconfiguration message). The base station may transmit an indicator that indicates the elevation angle threshold from a standardized list (or network configured list) of threshold values.

In some embodiments, the base station may also provide to the UE an elevation angle threshold θ_{TH}, which is to be applied to a satellite S_{PTC} corresponding to a potential target cell (PTC). The UE may receive ephemeris data for the satellite S_{PTC} from the satellite S_{PTC} (or from the network via the current serving cell); compute the location of the satellite S_{PTC} based on the ephemeris data; and compute the elevation angle θ_{sPTC} of the satellite S_{PTC} based on the satellite location and the UE's current GPS location. The UE may then compare the elevation angle θ_{sPTC} of the satellite S_{PTC} to the elevation angle threshold θ_{TH}. The UE may require the elevation angle θ_{sPTC} to be greater than the elevation angle threshold θ_{TH} to enable a handover to the potential target cell. In some cases, the elevation angle for a satellite corresponding to a potential target cell may be defined as a negative angle while the elevation angle for the current serving satellite may be defined as a positive angle. In those cases, the elevation angle threshold θ_{TH} is likewise a negative value, and the UE may require the elevation angle θ_{sPTC} to be less than the elevation angle threshold θ_{TH} to enable a handover to the potential target cell.

In some embodiments, if the elevation angle θ_{sPTC} of the satellite S_{PTC} is less than (or alternatively, greater than, depending on the sign convention on the elevation angle θ_{sPTC}) the elevation angle threshold θ_{TH}, and the serving satellite's elevation angle θ_{S} is less than the threshold θ_{CHO}, then the UE may test the one or more additional CHO conditions, e.g., as variously described above. The one or more additional CHO conditions may include a condition on the RF signal quality of the potential serving cell.

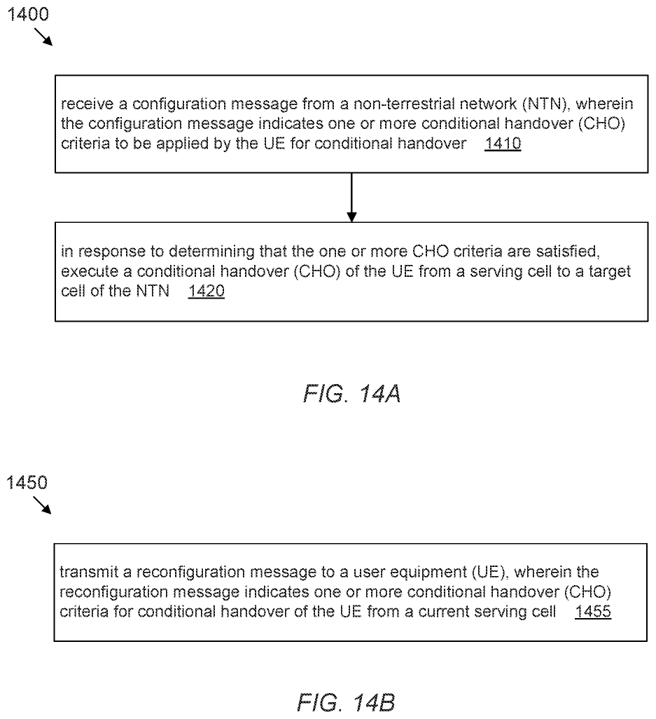

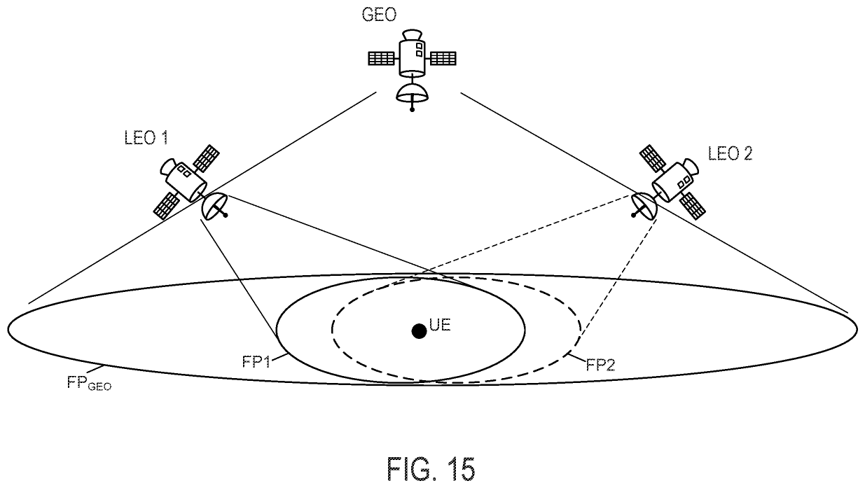

In one set of embodiments, a method 1300 for operating an apparatus may include the operations shown in FIG. 13A. The method 1300 may also include any subset of the features, elements or operations described above in connection with FIGS. 1-12, and described below in connection with FIGS. 14 and 15. The method 1300 may be performed by processing circuitry, e.g., by the processing element 610 of user equipment 600.

At 1310, the processing circuitry may receive information indicating an elevation angle threshold for a non-terrestrial platform (NTP) associated with a current serving cell of a non-terrestrial network (NTN). The elevation angle threshold may be received from a base station of the NTN, via the NTP.

At 1315, the processing circuitry may determine an elevation angle θ_{NTP} of the NTP. As illustrated in FIG. 13B, the elevation angle θ_{NTP} may be defined relative to a horizon line (or horizon ray), e.g., the horizontal line that resides in the plane defined by the UE's zenith ray and the vector V_{UE,NTP} that connects the UE location and the NTP location.

Returning to FIG. 13A, at 1320, in response to determining that the elevation angle θ_{NTP} is less than the elevation angle threshold, the processing circuitry may execute a conditional handover to a target cell of the NTN.

In some embodiments, the base station may reside on the earth, and send the elevation angle threshold to the UE via an NTP, e.g., the NTP associated with the current serving cell. Alternatively, the base station may be located in the NTP. In the context of 3GPP SGNR, the base station may be a gNB.

In some embodiments, the action of determining the elevation angle of the NTP may include determining a position of the NTP based on ephemeris data of the NTP; and determining the elevation angle of the NTP based the NTP position and a current location of the UE. The apparatus may include a GPS receiver to support the determination of the UE's current location.

In some embodiments, the processing circuity may receive a broadcast of the ephemeris data from NTP prior to said determining the elevation angle of the NTP.

In some embodiments, the processing circuitry may receive additional information indicating an additional elevation angle threshold for another NTP, which is associated with the target cell. Furthermore, the action of executing the conditional handover to the target cell may include verifying that an elevation angle of the other NTP satisfies an inequality condition with respect to the additional elevation angle threshold. As noted above, the sense of the inequality (greater than or less than) may depend on the sign convention used for the elevation angle.

In some embodiments, the information of action 1310 may be received as part of a reconfiguration message of a radio resource control (RRC) protocol, e.g., as variously described above.

In some embodiments, the action of executing the conditional handover may include verifying a validity of a condition on signal quality of the target cell, e.g., as variously described above.

In some embodiments, the NTP is a satellite or a high altitude platform (HAP).

In alternative embodiments, the UE may receive information indicating an elevation angle range for a non-terrestrial platform corresponding to a serving cell (or a potential target cell). The UE may calculate the elevation angle of the serving cell (or potential target cell), and determine whether the calculated elevation angle is within the elevation angle range. If so, the UE may execute (or initiate) a conditional handover from the serving cell (or, to the potential target cell) e.g., as variously described above. The base station may assign different elevation angle ranges to different UEs (or different subsets of UEs) in the serving cell.

In some embodiments, a method for operating a serving base station may include the following operations, to facilitate a conditional handover of a user equipment (UE) from a serving cell of a serving base station. The method may also include any subset of the features, elements or operations described above in connection with FIGS. 1-13, and described below in connection with FIGS. 14-15. The method may be performed by processing circuitry, e.g., by the processing element 710 of base station 700. In response to receiving a conditional handover acknowledgement, e.g., as described above in connection with FIG. 8, the processing circuitry may transmit a reconfiguration message indicating or specifying an elevation angle threshold for a non-terrestrial platform (NTP) of the NTN, e.g., a NTP that mediates the serving cell for the serving base station.

In response to receiving a reconfiguration complete message from the UE, the processing circuitry may transmit an early status transfer message to a target base station of the conditional handover, and start forwarding user data to the target base station. In response to an indication that the conditional handover of the UE to the target base station is complete, the processing circuitry may transmit a handover success message to the target base station.

In some embodiments, the processing circuitry is further configured to broadcast ephemeris data for one or more NTPs including the NTP of the serving cell.

In some embodiments, the processing circuitry may assign different elevation angle thresholds to different UEs (or different subsets of UEs), to spread out the load of CHO processing.

### Combination of Criteria for Conditional Handover

In some embodiments, a combination of two or more of the above-described CHO criteria may be employed, to provide a more robust conditional handover between satellite-based cells in the non-terrestrial network (NTN). For example, in one embodiment, the UE may employ a location-based criterion and a timer-based criterion (with network indicated time or network indicated time range). In another embodiment, the UE may employ a timer-based criterion (with network indicated time or network indicated time range) and an elevation based criterion. In yet another embodiment, the UE may employ a location based criterion and an elevation based criterion. In yet another embodiment, the UE may employ a location based criterion, a timer based criterion (with network indicated time or network indicated time range), and an elevation based criterion.

In one set of embodiments, a method 1400 for operating an apparatus may include the operations shown in FIG. 14A. The method 1400 may also include any subset of the features, elements or operations described above in connection with FIGS. 1-13 and described below in connection with FIGS. 14B-16. The method 1400 may be performed by processing circuitry, e.g., by the processing element 610 of user equipment 600.

At 1410, the processing circuitry may receive a configuration message from a non-terrestrial network (NTN), e.g., from a non-terrestrial platform of the NTN. The configuration message may indicate one or more conditional handover (CHO) criteria to be applied by the UE for conditional handover. Each CHO criterion of the one or more CHO criterion may be based on corresponding information other than signal quality, e.g., as variously described above. The configuration message may be realized by the reconfiguration message 814 of FIG. 8, or by the reconfiguration measurement index of the reconfiguration message 814.

At 1420, in response to determining that the one or more CHO criteria are satisfied, the processing circuitry may optionally execute a conditional handover (CHO) of the UE from a serving cell to a target cell of the NTN. The execution of the conditional handover may include testing one or more additional CHO conditions, e.g., one or more CHO conditions based on signal quality of potential target cell(s).

In some embodiments, the one or more CHO criteria may include a plurality of CHO criteria, wherein the CHO criteria of said plurality of CHO criteria are of different types. For example, the plurality of CHO criteria may include two or more of the following: a location-based CHO criterion; a timer-based CHO criterion with indicated time value; a timer-based CHO criterion with indicated time range; and an elevation-based CHO criterion.

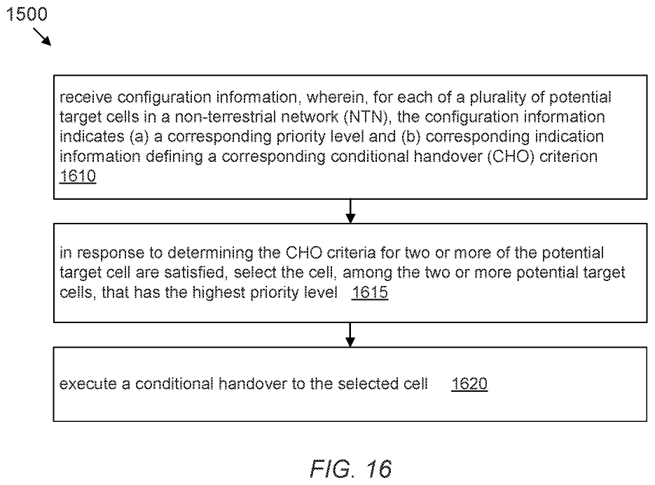

In one set of embodiments, a method 1450 for operating an apparatus in the context of a non-terrestrial network (NTN) may include the operations shown in FIG. 14B. The method 1450 may also include any subset of the features, elements or operations described above in connection with FIGS. 1-14A and described below in connection with FIGS. 15 and 16. The method 1450 may be performed by processing circuitry, e.g., by the processing element 710 of user equipment 700.

At 1455, the processing circuitry may transmit a reconfiguration message to a user equipment (UE), where the reconfiguration message indicates one or more conditional handover (CHO) criteria for conditional handover of the UE from a current serving cell of the NTN. The reconfiguration message may be realized, e.g., by the reconfiguration message 814 of FIG. 8 (or the reconfiguration measurement index of the reconfiguration message 814), e.g., as variously described above. Each of the one or more conditional handover criteria may be based on corresponding information other than signal quality.

In some embodiments, the one or more CHO criteria may include a plurality of CHO criteria, and the CHO criteria of said plurality of CHO criteria may be of different types. For example, the plurality of CHO criteria may include two or more of the following: a location-based CHO criterion; a timer-based CHO criterion with indicated time value; a timer-based CHO criterion with indicated time range; and an elevation-based CHO criterion.

In response to receiving a reconfiguration complete message from the UE, the processing circuitry may transmit an early status transfer message to a target base station of the conditional handover, and start forwarding user data to the target base station.

In some embodiments, the transmission operation 1455 may be performed in response to receiving a conditional handover acknowledgement message from each of one or more potential target cells of the UE, e.g., as described above in connection with FIG. 8.

### Prioritization Among Multiple NTN Cells

In some embodiments, there may be a plurality of NTN cells that can be configured for a UE. For example, the UE may be configured for a low earth orbit (LEO) satellite and a geosynchronous earth orbit (GEO) satellite. As another example, the UE may be configured for a high altitude platform (HAP) and a LEO satellite. As yet another example, the UE may be configured for a HAP and a GEO satellite. As yet another example, the UE may be configured for a medium earth orbit (MEO) satellite, a LEO satellite, and a HAP. As yet another example, the UE may be configured for a first LEO satellite (LEO1), a second LEO satellite (LEO2) and a GEO satellite, e.g., as shown in the FIG. 15. The cell mediated by the LEO1 may have a footprint FP1; the cell mediated by LEO2 may have a footprint FP2; and the cell mediated by the GEO may have a footprint FP_{GEO}. The UE may reside in two or more of the footprints FP1, FP2 and FP_{GEO}.

When the UE is configured for a plurality of non-terrestrial platforms (NTPs), it would be desirable to avoid the execution of conditional handovers between NTP-based cells in response to random (or short term) variations of the RF signal strength of the cells, e.g., especially when the target cell is already overburdened with client UEs. For example, it may be desirable to avoid unnecessary handovers to a GEO satellite, which may be responsible for covering a large geographical area, and thus, burdened with a large number of client UEs. (NTPs may include platforms such as GEOs, MEOs, LEOs, HAPs, etc., or any combination of the foregoing.)

In some embodiments, each potential target cell that has been configured for a UE is assigned (a) a corresponding priority level and (b) a corresponding initial CHO criterion for conditional handover to the potential target cell. The priority level and information defining the initial CHO for each potential target cell are transmitted to the UE by the network, e.g., via the current serving cell. For example, as shown in the Table below, which is correlated with FIG. 15, a GEO satellite cell may be configured with priority level 3, and with a location based criterion, using GNSS coordinates and GPS accuracy; a first LEO satellite (LEO1) cell may be configured with priority level 1, and with a timer based criterion, using time range [t1,t2] and a first random seed; and a second LEO satellite (LEO2) cell may be configured with priority level 2, and with a timer based criterion, using time range [t3,t4] and a second random seed.

TABLE
Prioritization Scheme

| Cell | Priority | CHO Criterion |
|---|---|---|
| GEO | Priority 3 | GNSS Coordinates, GPS accuracy |
| LEO1 | Priority 1 | TimeRange [t1, t2], randSeed1 |
| LEO2 | Priority 2 | TimeRange [t3, t4], randSeed2 |

At any given time, the UE may determine that the initial CHO criteria for two or more of the potential target cells are satisfied, in which case, the UE may select the cell (from the two or more potential target cells) that has the highest priority. The UE may then test one or more additional CHO criteria for conditional handover to the selected cell. The one or more additional CHO criteria may include a criterion based on the RF signal quality of the selected cell. If the one or more additional CHO criteria are satisfied, the UE may execute a handover to the selected cell. In at least some embodiments, the network may need to provide copies of continuing user data to all potential target gNBs since there is uncertainty on which target gNB the UE will move to. Though there is redundancy in having the user data copied at multiple potential targets, this procedure ensures latency is minimized.

In some embodiments, the network may transmit (to the UE) configuration information I_{C} that indicates, for each configured cell of the UE, (a) a corresponding priority level and (b) corresponding CHO parameters defining a corresponding CHO criterion. The corresponding CHO criterion may be selected from the CHO criteria described above. For example, the corresponding CHO criterion may be selected from the following list (or from a sublist of the following list):
location-based CHO criterion with network configured coverage area and size parameter;
timer-based CHO criterion with network configured time value;
timer-based CHO criterion with network configured time range and random seed;
timer-based CHO criterion with network configured time range and RNTI-based randomization;
elevation-based CHO criterion with network configured elevation threshold (or standard defined threshold).

In some embodiments, the reconfiguration message 814 of FIG. 8 (or the reconfiguration measurement index of the reconfiguration message 814) may include the above-described priority configuration information I_{PC}.

In some embodiments, the above-described prioritization scheme allows for a target cell to be selected, e.g., when RF conditions alone might not yield a clear winner among the configured candidates. The above-described priority scheme may be referred to herein as a modified conditional handover (m-CHO).

In some embodiments, the network may determine priorities for the configured cells based on one or more factors such as: reports received from the UE, e.g., reports of the quality of the signal received by the UE from each of the cells; measurements of traffic load in each of the cells; the frequencies of the cells; etc.

In one set of embodiments, a method 1600 for operating an apparatus may include the operations shown in FIG. 16. The method 1600 may also include any subset of the features, elements or operations described above in connection with FIGS. 1-15. The method 1600 may be performed by processing circuitry, e.g., by the processing element 610 of user equipment 600.

At 1610, the processing circuitry may receive configuration information. For each of a plurality of potential target cells in a non-terrestrial network (NTN), the configuration information may indicate: (a) a corresponding priority level and (b) corresponding indication information defining a corresponding conditional handover (CHO) criterion.

In some embodiments, each of the potential target cells has a different priority level from other potential target cells. In other words, different potential target cells are assigned different priority levels. In other embodiments, some (although not all) of the potential target cells might share the same priority level, and mechanisms based on one or more criteria other than priority level may be employed for tie breaking among potential target cells of the same priority level.

At 1615, in response to determining the CHO criteria for two or more of the potential target cell are satisfied, the processing circuitry may select the cell, among the two or more potential target cells, that has the highest priority level.

At 1620, the processing circuitry may execute a conditional handover to the selected cell, e.g., as variously described above.

In some embodiments, the above-described configuration information may be received as part of a reconfiguration message of a radio resource control (RRC) protocol, e.g., as part of the reconfiguration message 814 or the reconfiguration measurement index described above in connection with FIG. 8.

In some embodiments, for each of the potential target cells, the corresponding CHO criteria belong to a set of criteria including: a location-based CHO criterion; a timer-based CHO criterion; and an elevation-based CHO criterion.

In some embodiments, for each of the potential target cells, the corresponding CHO criteria belong to a set of criteria including: a location-based CHO criterion with network configured coverage area and size parameter; a timer-based CHO criterion with network configured time value; a timer-based CHO criterion with network configured time range and random seed; a timer-based CHO criterion with network configured time range and RNTI-based randomization; an elevation-based CHO criterion with network configured elevation threshold (or standard defined threshold); or a combination thereof.

In some embodiments, a first of the potential target cells corresponds to a geosynchronous satellite, and a second of the potential target cells corresponds to a non-terrestrial platform that is not a geosynchronous satellite.

In some embodiments, the action of executing the conditional handover to the target cell may include verifying a validity of a condition on signal quality of the target cell prior to handover to the target cell, e.g., as described above.

In some embodiments, the number of potential target cells in said plurality is greater than or equal to three, e.g., as suggested in the Table above.

In some embodiments, the apparatus may also include a GPS receiver configured to determine a current location of the UE in response to a request from the processing circuitry.

In some embodiments, a method for operating a serving base station may include the following operations, to facilitate a conditional handover of a user equipment (UE) from a serving cell of a serving base station. The method may also include any subset of the features, elements or operations described above in connection with FIGS. 1-16. The method may be performed by processing circuitry, e.g., by the processing element 710 of base station 700. The processing circuitry may transmit a reconfiguration message to a user equipment (UE). For each of a plurality of potential target cells (of the conditional handover) in a non-terrestrial network (NTN), the reconfiguration message may indicate (a) a corresponding priority level and (b) corresponding CHO information defining a corresponding conditional handover (CHO) criterion.

In some embodiments, in response to receiving a reconfiguration complete message from the UE, the processing circuitry may transmit an early status transfer message to a target base station of the conditional handover, and start forwarding user data to the target base station. In response to an indication that the conditional handover of the UE to the target base station is complete, the processing circuitry may transmit a handover success message to the target base station.

In some embodiments, the action of transmitting the reconfiguration message may be performed in response to receiving a conditional handover acknowledgement from each of the one or more potential target cells of the UE, e.g., as described above in connection with FIG. 8.

In some embodiments, the base station may be included a part of a non-terrestrial platform (NTP). The NTP may mediate one or more cells of the NTN. For example, the NTP may mediate a serving cell of the UE.

In some embodiments, the base station may be configured to wirelessly communicate with a non-terrestrial platform that mediates a serving cell of the UE.

In some embodiments, a non-transitory memory medium may store program instructions. The program instructions, when executed by processing circuitry, may cause the processing circuitry to perform any of the method embodiments described above, and any combination of those embodiments. The memory medium may be incorporated as part of a base station.

Embodiments of the present disclosure may be realized in any of various forms. For example, some embodiments may be realized as a computer-implemented method, a computer-readable memory medium, or a computer system. Other embodiments may be realized using one or more custom-designed hardware devices such as ASICs. Still other embodiments may be realized using one or more programmable hardware elements such as FPGAs.

In some embodiments, a non-transitory computer-readable memory medium may be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a computer system may be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The computer system may be realized in any of various forms. For example, the computer system may be a personal computer (in any of its various realizations), a workstation, a computer on a card, an application-specific computer in a box, a server computer, a client computer, a hand-held device, a user equipment (UE) device, a tablet computer, a wearable computer, etc.

Any of the methods described herein for operating a user equipment (UE) in communication with a base station (or transmission-reception point) may be the basis of a corresponding method for operating a base station (or transmission-reception point), by interpreting each message/signal X received by the UE in the downlink as a message/signal X transmitted by the base station (or transmission-reception point), and each message/signal Y transmitted in the uplink by the UE as a message/signal Y received by the base station (or transmission-reception point).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the embodiments above have been described in considerable detail, numerous variations and modifications will become apparent to those skilled in the art once the above disclosure is fully appreciated. It is intended that the following claims be interpreted to embrace all such variations and modifications.

1. An apparatus comprising processing circuitry, wherein the processing circuitry is configured to cause a user equipment (UE) to:
receive region information and a size parameter from a non-terrestrial network (NTN), wherein the region information indicates a region for a serving cell associated with a non-terrestrial platform (NTP) of the NTN, wherein the size parameter indicates a size of a neighborhood of a boundary of the region;
in response to determining that a current location of the UE is within the neighborhood, execute a conditional handover (CHO) of the UE from the serving cell to a target cell of the NTN.

2. The apparatus of claim 1, wherein the NTP is a satellite or a high altitude platform (HAP).

3. The apparatus of claim 1, wherein the region information and the size parameter are received as part of a reconfiguration message of a radio resource control (RRC) protocol.

4. The apparatus of claim 3, wherein the region information and the size parameter are received as part of a measurement index of the reconfiguration message.

5. The apparatus of claim 1, wherein the processing circuitry is further configured to cause a user equipment (UE) to:
receive additional region information and an additional size parameter for the target cell of the NTN, wherein the additional region information indicates an additional region, for
the target cell, wherein the additional size parameter indicates a size of an additional neighborhood, that includes a boundary of the additional region,
wherein said execution of the conditional handover to the target cell is further conditioned upon the current location of the UE being within the additional neighborhood.

6. The apparatus of claim 1, wherein the UE include a GPS receiver, wherein the GPS receiver is configured to determine the current location of the UE in response to a request from the processing circuitry.

7. The apparatus of claim 1, wherein said execution of the conditional handover includes testing a condition on signal quality of the target cell.

8. The apparatus of claim 1, wherein the region corresponds to a coverage area of the serving cell.

9. An apparatus comprising processing circuitry, wherein the processing circuitry is configured to cause a user equipment (UE) to:
receive time information from a non-terrestrial network (NTN), wherein the time information is associated with a serving cell of the NTN;
in response to receiving the time information, initiate a timer with a time value that is determined using the timer information;
in response to expiration of the timer, execute a conditional handover (CHO) of the UE from the serving cell to a target cell of the NTN.

10. The apparatus of claim 9, wherein the time information includes an indication of the time value.

11. The apparatus of claim 9, wherein the time information includes a random seed and an indication of a time range, wherein the time value is randomly selected from the timer range based on the random seed.

12. The apparatus of claim 9, wherein the time information includes: a UE specific random value; and an indication of a time range, wherein the time value is selected from the time range based on the UE specific random value.

13. (canceled)

14. The apparatus of claim 9, wherein the time information is received as part of a reconfiguration message of the radio resource control (RRC) protocol.

15. The apparatus of claim 9, wherein said execution of the conditional handover includes verifying a validity of a condition on signal quality of the target cell.

16. An apparatus comprising processing circuitry, wherein the processing circuitry is configured to cause a user equipment (UE) to:
receive information indicating an elevation angle threshold for a non-terrestrial platform (NTP) associated with a current serving cell of a non-terrestrial network (NTN);
determine an elevation angle of the NTP;
in response to determining that the elevation angle is less than the elevation angle threshold, execute a conditional handover to a target cell of the NTN.

17. The apparatus of claim 16, wherein said determining the elevation angle of the NTP includes:
determining a position of the NTP based on ephemeris data of the NTP; and
determining the elevation angle of the NTP based the NTP position and a current location of the UE.

18. The apparatus of claim 17, wherein the processing circuity is further configured to cause the UE to receive a broadcast of the ephemeris data from NTP prior to said determining the elevation angle of the NTP.

19. The apparatus of claim 16, wherein the processing circuitry is further configured to cause the UE to receive additional information indicating an additional elevation angle threshold for another NTP, which is associated with the target cell, wherein said executing the condition handover to the target cell include verifying that an elevation angle of said another NTP satisfies an inequality condition with respect to the additional elevation angle threshold.

20. The apparatus of claim 16, wherein the information is received as part of a reconfiguration message of a radio resource control (RRC) protocol.

21. The apparatus of claim 16, wherein said execution of the conditional handover includes verifying a validity of a condition on signal quality of the target cell.

22-42. (canceled)
